(19) United States
(12) Patent Application Publication
(10) Pub. No.: US 2016/0241530 A1
(43) Pub. Date: Aug. 18, 2016

(54) SYSTEMS AND METHODS FOR MANAGING ACCESS TO MESSAGE CONTENT

(71) Applicant: VONAGE NETWORK LLC, Holmdel, NJ (US)

(72) Inventors: Alexandra Andreev, Akko (IL); Sagi Iltus, Hadera (IL); May Ben Arie, Raanana (IL); Eli Birger, Petah Tikva (IL); Erez Nahum, Tel-Aviv (IL)

(21) Appl. No.: 14/620,736

(22) Filed: Feb. 12, 2015

(51) Int. Cl. H04L 29/06; G06F 3/0484; H04L 12/58; G06F 3/0488

(52) U.S. Cl. CPC H04L 63/08; G06F 3/0488; G06F 3/04842; H04L 51/12

(57) ABSTRACT

Systems and methods for selectively managing access to message content at a first display terminal are configured to display one or more messages collectively defining an exchange between a user of the first display terminal and a user of a second display terminal. The method determines, by a processor, that secure display processing should be used on at least one message of the exchange at the first display terminal, and displays message content of one or more messages of the exchange while concealing message content of the at least one message. In an embodiment, a successfully authenticated user or one who presents a required decryption code is able to view all any portion of an exchange, such as the at least one message in the context of a plurality of messages comprising a conversation.

### BACKGROUND

1. Field of the Invention

Embodiments consistent with the present invention generally relate to methods and apparatus for presenting message content generated, exchanged and/or received by a user display terminal.

2. Description of the Related Art

Over the course of weeks, months or even years, the user of a display-equipped communications terminal such, for example, as a mobile phone, smartphone, tablet computer, personal digital assistant, or a laptop, notebook, or desktop computer (each, a “user display terminal”), may accumulate hundreds or even thousands of incoming and outgoing text, chat, and/or e-mail messages. Even voice mail messages are now commonly converted to text and forwarded as e-mail messages to the user display terminal of the intended recipient.

As the volume of generated or received messages locally stored at a user display terminal increases, so too does the potential for harm if the device were ever to be lost or stolen. Some messages, for example, may contain non-public information personal to the user such, for example, as a social security number, bank account numbers, account passwords, a birth date, or the like. Permitting an unintended recipient to access such message content could facilitate identity theft or unauthorized withdrawal of funds from financial accounts. Moreover, many enterprise employers are now modifying their business communication platforms to implement Bring Your Own Device (“BYOD”) operation. While this shift away from enterprise owned communication devices can be a considerable source of cost savings for an employer, any proprietary information embodied in message content locally stored on a user displayed device is potentially susceptible to unauthorized access.

Accordingly, there is a need for improved methods and systems for managing access to message content at a user display terminal.

### SUMMARY

The inventors herein propose systems and methods operative to designate, for secure display processing, one or more messages exchanged between users of user display terminals and to selectively present messaging content, to the users of such display terminals based on the presence or absence of such designation.

In some embodiments, the method includes receiving a request to display, at a first display terminal, one or more messages collectively defining an exchange between a user of the first display terminal and a user of a second display terminal, determining, by a processor, that secure display processing should be used on at least one message of the exchange at the first display terminal, and displaying message content of one or more messages of the exchange while concealing message content of the at least one message.

In some embodiments, the method includes receiving, at a first display terminal, user input corresponding to both message content of a first message and to a request to designate the first message for secure display processing, receiving a second message not designated for secure display processing. The method in some embodiments includes determining if the user of the first display terminal is authorized to view the first message and, if so, initiating display of the first message together with the second message or, if not, initiating display of the second message without the first message.

In some embodiments, a system for managing access to message content at a user display terminal comprises a display, a processor, and a memory containing instructions executable by the processor. When executed, the instructions stored in memory cause the processor to initiate display of one or more messages collectively defining an exchange conversation between a user of the first display terminal and a user of a second display terminal, to determine whether secure display processing should be used at the first user display terminal, and if it is determined secure display processing should be used on a message of the exchange, to initiate display of message content of one or more messages of the plurality not determined to initiate display of message content of one or more messages of the exchange without displaying message content of the at least one message.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A depicts a block diagram of a system for managing access to message content at a user display terminal, according to one or more embodiments of the invention;

FIG. 1B depicts a block diagram of a system for managing access to message content at a user display terminal, according to one or more other embodiments of the invention;

FIG. 2 is a flow diagram of a method for managing access to message content at a user display terminal according to one or more embodiments of the invention;

FIG. 3 is a flow diagram of a method for facilitating secure display processing of message content created, received and/or edited at a user display terminal as, for example, a sub-process of the method of FIG. 2, according to one or more embodiments of the invention;

FIG. 4 is a flow diagram of a method for determining if a user of a display terminal is entitled to view message content subject to secure display processing as, for example, a sub-process of the method of FIG. 2, according to one or more embodiments of the invention;

FIG. 5 is a flow diagram of a method for selectively performing secure display processing for a message forming part of an exchange of messages as, for example, a sub-process of the method of FIG. 2, according to one or more embodiments of the invention;

FIG. 6 is a flow diagram of a method for selectively performing secure display processing for a message forming part of an exchange of messages as, for example, a sub-process of the method of FIG. 2, according to one or more embodiments of the invention;

FIG. 7A depicts a display terminal operated by a user to visually present a sequence of messages forming at least part of a conversation and to create, edit or forward a message containing sensitive, proprietary, or confidential information as part of that conversation, according to one or more embodiments of the invention;

FIG. 7B depicts the display terminal of FIG. 7A following the application of keyword recognition to a message created or accessed by a user but prior to forwarding of that message to a recipient, the detection of a keyword automatically initiating display of a prompt to the user to invoke secure display processing, according to one or more embodiments of the invention;

FIG. 7C depicts the display terminal of FIGS. 7A and 7B operated by a user to visually present messages forming part of a conversation that includes at least one message for which secure display processing has been performed and at least one message for which secure display processing has not been performed, according to one or more embodiments of the invention;

FIG. 7D depicts the display of the same conversation as seen in FIG. 7C, but on a second display terminal operated by a second user to visually present that conversation from the perspective of a recipient of a message requiring secure display processing according to one or more embodiments of the invention; and

FIG. 8 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention include a system and method for designating, for secure display processing, one or more messages originated by and/or received by the user(s) of one or more display terminal(s), and for selectively presenting messaging content—corresponding to a single message, a number of messages related by subject, topic or recipient, or an exchange of such messages between participants in a conversation—to the users of such display terminals based on the presence or absence of such designation. Some exemplary embodiments consistent with the claimed invention offer an alternative to more onerous security protocols such as device lockout passwords and/or “universal message encryption”. Many users consistently avoid implementing such alternative protocols because they regard these as inconvenient or labor-intensive. Such users often consider the risk of identity theft or industrial espionage to be remote, and may have never experienced the loss or misplacement of an unprotected mobile phone, a personal digital assistant (PDA), a tablet computer or a laptop, notebook or desktop computer.

Embodiments consistent with the claimed invention provide a user interface which enables, within the context of an exchange of messages, a message author and/or recipient to selectively invoke access protection (i.e., secure display processing) for some messages while not invoking it for others. An exchange of messages may be a unidirectional sequence of messages originating from a single author/creator and distributed to one more recipients, or an exchange may be a bidirectional sequence of messages constituting a conversation between multiple participants. The message(s) comprising a single exchange may be Short Message Service (SMS) messages, Multimedia Messaging Service (MMS) messages, push notifications, instant message (IM) chat messages, e-mail messages, a combination thereof, or even messages posted to an otherwise public social networking service such as Facebook which enables its subscribers to selectively limit the distribution of messages to one or more specified individuals in a “closed” group.

In some embodiments, the recipient of a message protected by secure display processing is authenticated using his or her own password rather than one supplied by the originator of the protected message. In others, a previously shared password is used. Where a conversation includes both protected and unprotected messages, the protected messages may be withheld (not rendered to a display at all), obscured, encrypted, or otherwise concealed. In some embodiments, the display terminal is operative to display a notification indicating that protected content is available for access. In some embodiments, a display terminal is configured to generate and initiate display of a prompt requesting entry of a code such, for example, as a password or decryption key in response to a user request for display of a conversation containing protected message content.

Various embodiments of systems and methods for managing access to message content at a user display terminal are provided below. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

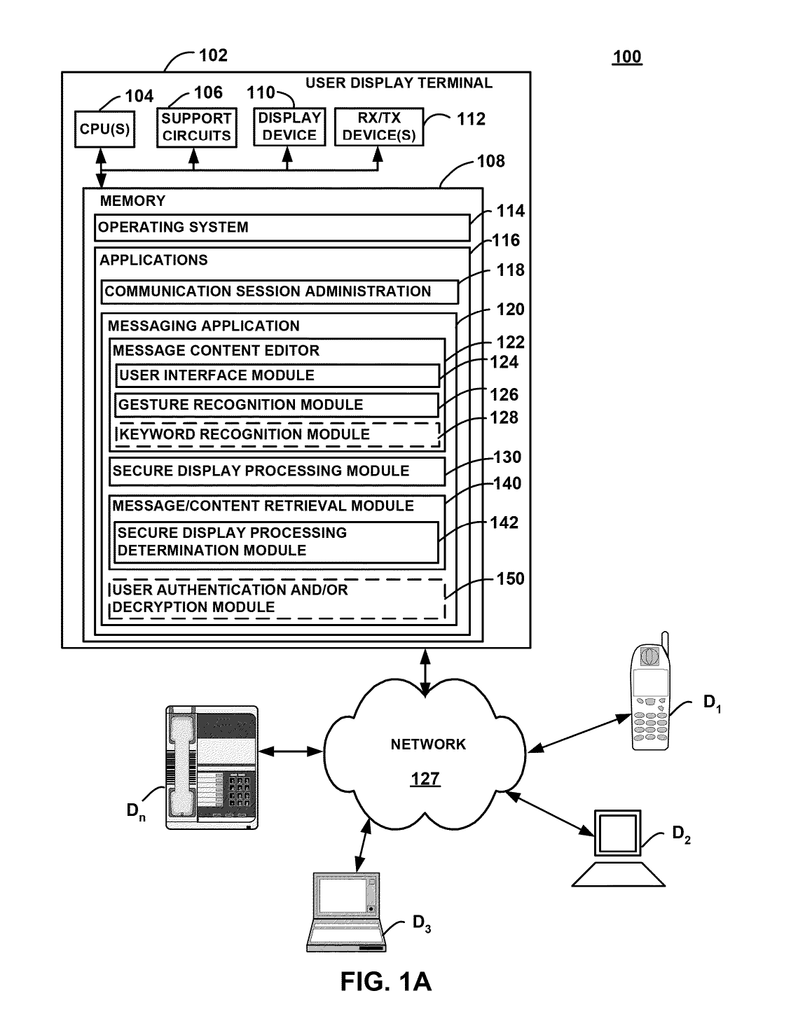

FIG. 1A depicts a block diagram of an end user device 102 (“display terminal”) for managing access to message content exchanged between device 102 and one or more other display terminals as devices D₁ to Dₙ, according to one or more embodiments consistent with the claimed invention. The display terminal 102 comprises Central Processing Unit (CPU) 104, support circuits 106, a memory 108, a display device 110, and one or more transceiver device(s) 112. In some embodiments, display terminal 102 is a portable communication device having an integral display such, for example, as a mobile phone or smartphone (D₁), a tablet computer (not shown), or a notebook or laptop computer (D₃), and the transceiver device(s) 112 comprises one or more wireless transceivers compliant with corresponding wireless transmission protocol(s) such as IEEE 802.11, IEEE 802.13, Bluetooth, and/or cellular transmission protocols such as CDMA, TDMA, and/or GSM. In other embodiments, the display terminal 102 is a desktop device with an integral and/or adjunct display such, for example, as a desktop computer (D₂) or telephone (Dn).

The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, and the like. The memory 108 comprises at least one of Read Only Memory (ROM), Random Access Memory (RAM), disk drive storage, optical storage, removable storage and/or the like. In some embodiments, the display device 110 includes a touch screen able to sense gesture input in response to movement of a user's finger or a stylus. In some embodiments, the memory 108 comprises an operating system 114 and one or more applications 116.

In some embodiments, applications 116 include a communication session administration module 118 configured, by execution of instructions by CPU 104, to set up a telephone call or to send e-mail, IM chat, SMS or MMS, or social media messages to an intended recipient via communication network 127. The content of each message may include one or more of alphanumeric text, multimedia images or files, and/or packetized speech. In unified communication systems, packetized speech received at a voice mail server may be converted to text and made available for retrieval, as an e-mail message, by an intended recipient. Where notification of such capability is available from the voice mail server, some embodiments of display terminal 102 are configured to facilitate secure display processing for the resulting e-mail message. As will be described in detail shortly, in some embodiments, a user may either manually designate a message for secure display processing or the message itself may be subjected to an automated evaluation process to detect one or more keywords having a correlation to the presence of proprietary, confidential, or sensitive information.

The network 127 comprises one or more communication systems that connect computers by wire, cable, fiber optic and/or wireless link facilitated by various types of well-known network elements, such as hubs, switches, routers, and the like. The network 127 may include one or more of an Internet Protocol (IP) network, a public switched telephone network (PSTN), a local area network (LAN), a wide area network (WAN), a metropolitan area network (MAN) and/or mobile communication networks, and may employ various well-known protocols to communicate information amongst the network resources.

In embodiments, applications 116 stored within memory 108 and executable by processor(s) 104 further include a messaging application 120. The messaging application 120 includes a message content editor 122 having a user interface module 124, a gesture recognition module 126 and, in some embodiments, an optional keyword recognition module 128. The message application 120 further includes a secure display processing module 130 and a message content retrieval module 140 having a secure display processing determination module 142. In some embodiments, message application 120 optionally includes a user authentication and/or message content decryption module 150.

In some embodiments, messages processed by messaging application 120 are SMS, IM or Group Chat messages, and messaging content editor 122 is used to create new messages as part of an ongoing exchange of messages (i.e., a “conversation”) between two or more users of display terminals as display terminal 102. The user interface module 124 interacts with message content retrieval module 140 to retrieve earlier messages of a conversation from local storage in memory 108 or from remote storage at a server (not shown in FIG. 1A) so that a message being created or edited is rendered, in its context, to display device 110. In some embodiments, a user manually designates the message being created or edited for secure display processing by secure display processing module 130. In an embodiment, gesture recognition module 126 is configured to recognize touch screen input made by a user using a finger or stylus. If the gesture is associated with an instruction to invoke a secure display processing designation for a message, secure display processing module 130 initiates concealment of the message responsive to the designation. In other embodiments, display terminal 102 initiates rendering of one or more “soft” feature button(s) to display device 110 so that a user may elect and/or refuse secure display processing for the message.

In embodiments where the display terminal 102 initiates rendering of one or more “soft” feature button(s), the appearance of the feature button(s) may be initiated responsive to the operation of keyword recognition module 128. By way of illustrative example, the secure display processing module may, through an application programming interface (API) or other mechanism, receive input confirming the presence of sensitive, confidential, or proprietary information.

It should be emphasized that embodiments consistent with the present disclosure are not limited to the mobile display terminals or to display terminals equipped with a touch screen user interface. In some embodiments, secure display processing is performed by execution of instructions, associated with a messaging application, by the processor of a desktop, notebook or laptop.

In an embodiment, secure display processing module 130 is configured to enforce policies which can vary according to the classification of the keywords. For example, in a Bring Your Own Device enterprise setting, a first class of confidential and proprietary information entitled to a very high level of protection by employer “Company X” (as indicated by a first set of keywords and/or phrases in memory) could be separately identified via the API to trigger display of an alert that the message appears to contain highly sensitive information proprietary to Company X and will be blocked unless the user confirms, by touching a soft “confirm” button rendered to the display, that the message contains no such information or that it is being sent to an authorized recipient. Following such confirmation, “send” and “cancel” feature buttons might be displayed. For a second class of confidential or proprietary information (as indicated by a second set of key words and/or phrases) subject to a lower level of protection by Company X, the “send” and “cancel” buttons and an alert noting the detection of possible keyword(s) might be displayed without first displaying a “confirm” button and without waiting to receive a “confirm” or “cancel” input from the user.

For a purely personal device (i.e., one that is not also configured to access enterprise resources), all information identified by keyword or phrase recognition might be processed in the same manner as the second class of protected information described in the enterprise example above. In either case, keyword recognition is a useful, though not necessary, adjunct to encryption capabilities consistent with embodiments of the present disclosure.

If keyword recognition is used, it may be a locally executed (i.e., at display terminal 102) or a remotely executed (e.g., at a server) function. In some embodiments, keyword recognition module 128 may be pre-configured to associate certain characters, words, phrases and/or the presence of numeric strings with the presence of personally sensitive information. For example, any or all of the single symbol “#”, the single word “password” or “number”, or the phrase “account number” may be stored as part of the pre-configuration of keyword recognition module 128. In embodiments, the user or a network administrator responsible for the configuration of module 128 may periodically add or remove symbols, words and/or phrases may from a database (not shown) forming part of keyword recognition module. Such updating is especially advantageous for projects having only transient sensitivity to an enterprise employer providing the user of terminal device with access to network resources such, for example, as a file or message exchange server.

In some embodiments, secure display processing module 130 conceals one or more designated message(s) forming part of a conversation by not rendering the designated message(s) once they have been stored and/or forwarded to the intended recipient(s). In some embodiments, one or more other messages of the same conversation are displayed, with a blank space or a notification or symbol identifying the location of any missing message(s).

Another option for concealment consistent with embodiments of the claimed invention include obfuscation (e.g., writing extraneous characters in place of selected numbers, words or phrases portions or even the entire content of any message of a conversation designated for secure display processing). Yet another option for concealment includes rendering the designated message (or portion thereof) in a color which matches that of the display background so that it is indistinguishable from the background. Yet another option for concealment includes encrypting the designated message (or portion thereof) so that it is displayed, if at all, in the encrypted format. In some embodiments, the encryption need only be carried out locally. That is, the transmitted message designated for secure processing need only be stored and/or transmitted (forwarded) with a designation or tag that triggers secure processing by the display terminals of the message author and intended recipients. Thus, a message designated for secure display processing need not actually be transmitted in an encrypted format.

When the creator or recipient of a message designated for secure display processing subsequently desires to operate display terminal 102 to retrieve and display a message so designated in the context of a conversation containing a plurality of messages, the user interface module 124 requests retrieval of the message either from storage in local memory or from a remote server (depending upon where the messages are stored). Secure display processing determination module 142 determines whether or not any message(s) of the applicable conversation are designated to trigger secure display processing. If so, in some embodiments, secure display processing module 130 initiates display of the conversation subject to the concealment of any messages designated for secure display processing.

In some embodiments consistent with the claimed invention, the implementation of secure display processing by module 130 is deferred so that the concealment of messages within a conversation is not performed at display terminal 102 unless or until the owner or assigned user of that terminal reports the device as lost or stolen. In other embodiments, such processing is not deferred so that an authentication and/or decryption process is performed by user authentication and/or decryption module 150. The authentication process may be performed locally at display terminal 102 or by an authentication server accessed via network 127. As part of the authentication process, in some embodiments the user is prompted to enter a password or to provide biometric input (e.g., via a finger print recognition). In addition, or alternatively, the user may be prompted to enter a decryption key. It is, of course, not necessary to initiate display of a prompt to the user of display terminal 102. In alternate embodiments, a “locked” status indicator may be provided which alerts the user to the presence of data requiring secure display processing as a condition of its being displayed by display device 110. In some such embodiments, the gesture recognition module 126 is configured to detect the entry of a gesture for invoking the authentication and/or decryption process(es).

The operating system (OS) 114 generally manages various computer resources (e.g., network resources, file processors, and/or the like). The operating system 114 is configured to execute operations on one or more hardware and/or software modules, such as Network Interface Cards (NICs), hard disks, virtualization layers, firewalls and/or the like. Examples of the operating system 114 may include, but are not limited to, LINUX, MAC OSX, BSD, UNIX, MICROSOFT WINDOWS, and the like.

FIG. 1B depicts a block diagram of a computer (“server”) 162 for managing access to message content exchanged between devices such as display terminal 102 configured as illustrated and described in connection with FIG. 1A and one or more other display terminals as devices D₁ to Dₙ, according to one or more embodiments consistent with the claimed invention. FIG. 1B is similar to FIG. 1A but is directed to a server-implementation of at least some of the message creation, retrieve and/or secure display processing functions. The server 162 comprises one or more CPU(s) 164, support circuits 166, a memory 168, a display device 170, and transmission and receiving devices 172. In some embodiments server 162 comprise one or more wireless transceivers compliant with corresponding wireless transmission protocol(s) such as IEEE 802.11, IEEE 802.13, BLUETOOTH, and/or cellular transmission protocols such as CDMA, TDMA, and/or GSM, and/or any other suitable network protocol.

The CPU(s) 164 may comprise one or more commercially available microprocessors or microcontrollers that facilitate data processing and storage. The various support circuits 166 facilitate the operation of the CPU(s) 164 and include one or more clock circuits, power supplies, cache, input/output circuits, and the like. The memory 168 comprises at least one of Read Only Memory (ROM), Random Access Memory (RAM), disk drive storage, optical storage, removable storage and/or the like. In some embodiments, the display device 170 may be a touch screen able to accept input from a user's finger or input from a stylus. In some embodiments, the memory 168 comprises an operating system 174 and one or more applications 176. In some embodiments, applications 176 include a communication session administration module 178 configured, by execution of instructions by CPU(s) 164, to set up a telephone call or send an SMS, MMS, e-mail, or social media message between intended recipients using display terminals as terminal 102 and D′₁ to D′ₙ via network 127.

The operating system (OS) 174 generally manages various computer resources (e.g., network resources, file processors, and/or the like). The operating system 174 is configured to execute operations on one or more hardware and/or software modules, such as Network Interface Cards (NICs), hard disks, virtualization layers, firewalls and/or the like. Examples of the operating system 174 may include, but are not limited to, LINUX, MAC OSX, BSD, UNIX, MICROSOFT WINDOWS, ANDROID, and the like.

In some embodiments, applications 176 stored within memory 168 and executable by processor(s) 164 further include a messaging application 180. The messaging application 180 includes a message content editor 182 having a user interface module 184 and, in some embodiments, an optional keyword recognition module 186. In some embodiments, messaging application 180 further includes a gesture recognition module (not shown), though in the embodiment of FIG. 1B it is contemplated that the functions of this latter module are performed by a display terminal as terminal 102 executing a messaging client application. As well, message application 180 includes a secure display processing module 188, a message content retrieval module 190 having a secure display processing determination module 192 and, in some embodiments, message application 180 includes a user authentication and/or message content decryption module 194. In some embodiments, the keyword recognition module 186 may be pre-configured to associate certain characters, words, phrases and/or the presence of numeric strings with the presence of personally sensitive information. For example, any or all of the single symbol “#”, the single word “password” or “number”, or the phrase “account number” may be stored as part of the pre-configuration of keyword recognition module 186. In embodiments, the user or a network administrator responsible for the configuration of module 186 may periodically add or remove symbols, words and/or phrases may from a database (not shown) forming part of keyword recognition module. Such updating is especially advantageous for projects having only transient sensitivity to an enterprise employer providing the user of terminal device with access to network resources such, for example, as a file or message exchange server. In some embodiments, the keyword recognition module 186 may flag keywords that should be concealed by the user device or otherwise under secure processing on the user device.

The functions described in connection with the embodiment of FIG. 1A may be distributed between display terminal 102 and server 162 so as to make efficient use of server side resources and network administration resources.

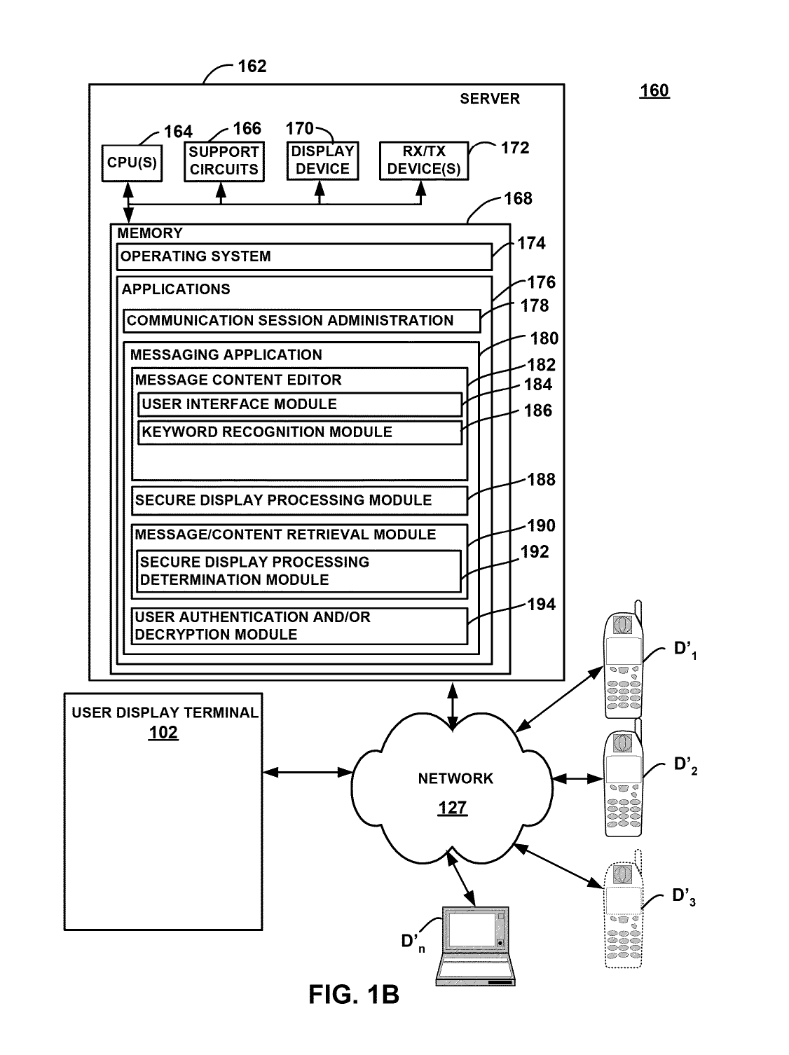

FIG. 2 is a flow diagram of a method 200 for managing access to message content at a user display terminal according to one or more embodiments of the invention. The method 200 starts at 202, and generally proceeds to 204.

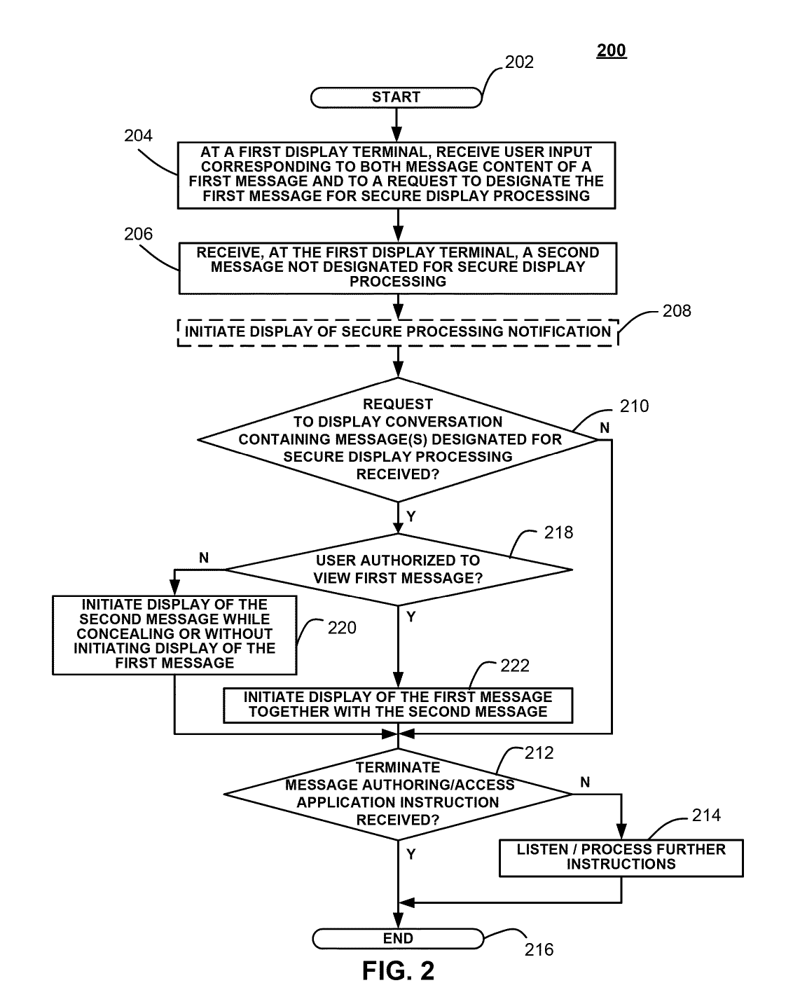

At 204, the method 200 receives, at a first display terminal comprising a display, processor, and memory containing executable instructions, user input corresponding to message content of a first message created or edited by a user. The method 200 further receives a request to designate the first message for secure display processing. In some embodiments, the secure processing is immediately implemented responsive to the request. In other embodiments, the secure processing is implemented only responsive to some other exogenous event such, for example, a receipt at the first display terminal of an instruction pushed from a communication network after the first display terminal has been reported lost or stolen. As will be discussed in greater detail with reference to FIG. 3, the first message may be stored locally, uploaded to a remote server for storage there, and/or forwarded to one or more intended recipients.

The method 200 proceeds from 204 to 206. At 206, method 200 receives at the first display terminal a second message which has not been designated to receive secure display processing. [The first and second messages received by method 200 at 204 and 206, respectively, may form part of an ongoing conversation which a user of the first display terminal may wish to view concurrently for proper context. The first and second messages may be SMS messages, MMS, messages, e-mail messages, instant message client (IM) chat messages, or social media messages shared with one or more individuals comprising a “closed” network of participants/subscribers. It should be noted that although an embodiment of method 200 wherein 204 precedes 206 has been shown and described, the order in which these sub-processes are performed may be reversed without departing from the spirit and scope of the present disclosure.

In some embodiments, method 200 proceeds to an optional step 208, at which the method 200 initiates display of a secure processing notification alerting each user of a display terminal—within the closed network having access to the conversation—that the conversation is subject to secure display processing. In other embodiments, method 200 proceeds directly to determination 210. If a user inputs, via a user interface displayed to the first display terminal, a request to initiate display of a particular conversation, a determination is made at 210 as to whether the conversation includes any messages containing content subject to secure display processing. If not, the method 200 proceeds to 212, for a determination as to whether the user of the first display terminal has input a request to terminate a message authoring and/or accessing application, being executed by a processor either locally at the first display device or remotely at a server.

If it is determined at 212 that no such instruction has been received, then the method 200 proceeds to 214 and listens for, and processes, the next instruction resulting from execution of the message authoring and/or accessing application. If, however, method 200 determines at 212 that an instruction to terminate the application has been received, the method 200 terminates at 216.

If at 210, method 200 determines that a conversation to be displayed does include one or more messages containing content subject to secure display processing, method 200 proceeds to 218. At 218, method 200 determines whether or not the user operating the first display terminal is authorized to view the first message within the context of the conversation which also includes messages not subject to secure display processing (i.e., not containing no viewing restrictions) such, for example, the second message. If method 200 determines at 218 that the user is not authorized to view the first message, then method 200 initiates display of the second message (and, optionally, any other messages of the conversation not subject to secure display processing), but conceals (e.g. hides, withholds from display, obfuscates, and/or encrypts) the first message along with any other messages subject to secure display processing. Method 200 then proceeds from 220 to 212 according to the illustrative sequence previously described.

If, instead, method 200 determines at 218 that the user is entitled to view the conversation free of viewing restrictions, then method 200 initiates display of the first message together with the second message at the first display terminal. In some embodiments, a single password selected by the user of the first display terminal is used to establish that the user is authorized to see all messages of a conversation without regard to who created the message. In other embodiments, each message of a conversation may be subjected to a discrete authentication process wherein the user of the first display terminal establishes authorization to view the content of messages on a message-by-message basis. Once the conversation has been displayed at the first display terminal, the method 200 proceeds from 222 to 212 according to the illustrative sequence previously described.

FIG. 3 is a flow diagram of a method 300 for facilitating secure display processing of message content created, received and/or edited at a user display terminal as, for example, a sub-process of the method 200 of FIG. 2, according to one or more embodiments of the claimed invention.

The method 300, as a sub-process of method 200, proceeds from 202 and is initiated at 302 where, by execution of instructions by a processor residing at the user display terminal and/or at a server (in a server-client arrangement), the method 300 launches a message authoring, editing, and/or retrieval-for-viewing application from the user display terminal. From 302, the method 300 proceeds to 304 where a message which contains confidential, proprietary and/or personally sensitive information and which has been created, edited or otherwise retrieved using the display terminal, is readied for local storage, remote storage, or transmission to one or more recipients belonging to a closed set of n user(s) or subscriber(s) which are parties to a message, an exchange of messages, or a conversation (in which case the exchanged messages are related by subject, topic or temporally), where n is an integer having a value equal to or greater than one but, in the usual case, is greater than one and involves two or more participants.

From 304, the method 300 optionally proceeds to 306, where method 300 automatically performs an automated search, by execution of instructions by a processor, to detect the presence of one or more keywords or characters frequently associated with the exchange of confidential or sensitive information. As noted previously, examples of these may include specific symbols such as the “#” character, the words “number” or “password” or phrases like “account number” “social security number,” “bank account” and the like. In enterprise-specific examples, however, phrases identifying specific products under development, a product vendor or customer, or a merger and acquisition project, might also be specified by, for example, a network administrator.

From 306 (or directly from 304 if 306 is omitted), the display terminal may optionally proceed to 308, where the display terminal is automatically caused, by execution of instructions by a processor, to cause the display of a prompt for the user to confirm the presence or absence of sensitive content. Typically, such a prompt is appropriate if a list of keywords, phrases or character to be automatically recognized are broadly inclusive, but it may be omitted in favor of a user-initiated request for secure display processing. At the most invasive (and certainly least user friendly) extreme, the user can be prompted to confirm the applicability of secure display processing for each readied message regardless of its content (i.e., in the absence of keyword analysis). Other options consistent with the present disclosure include prompting (or permitting) the user to selectively designate a particular conversation, and automatically applying secure display processing to a specific message or entire conversation when a specific keyword or phrase is identified in a message.

In any event, from 308, method 300 proceeds to step 310 where method 300 receives user input such, for example, as a specific touchscreen gesture or keypad macro sequence specifying that the message being readied for storage and/or transmission requires a designation for triggering secure display processing and/or secure display processing treatment. From step 310, method 300 optionally proceeds to 312. In some embodiments, a user who has not already established a single code for use in authenticating a subsequent use of his or her display terminal to view the message being readied is prompted to at 312 to enter such a code. Alternatively, in embodiments where a code is to be shared with each user that is or is to be a party to a specific exchange or conversation, the user may be requested at 312 to either specify such a code or request that one be randomly generated and distributed to the participants as, for example, by a voice mail message or a distribution mechanism accessed independently of the message authoring application launched at 302.

The method 300 proceeds from 310 or 312 (as the case may be) to 314, where method 300 stores and/or transmits (forwards) the message designated as requiring secure display processing so that it may be subsequently retrieved by the message author and/or intended message recipients or participants to a conversation. From 314, method 300 returns to method 200 by proceeding to 206 thereof.

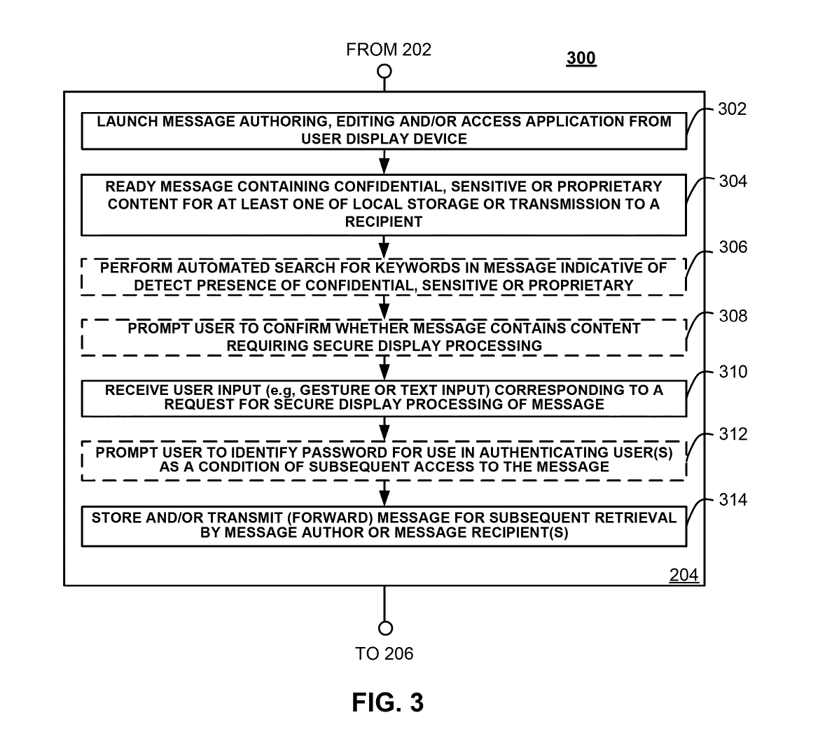

FIG. 4 is a flow diagram of a method 400 for determining if a user of a display terminal is entitled to view message content subject to secure display processing as, for example, a sub-process of the method 200 of FIG. 2, according to one or more embodiments of the invention. The method 400, as a sub-process of method 200, proceeds from 210 and is optionally initiated at 402 where, by execution of instructions by a processor residing at the user display terminal and/or at a server (in a server-client arrangement), the method 400 prompts the user of the first display terminal to enter authentication credential(s) such as a code and/or a password or decryption key.

If 402 is omitted, method 400 proceeds directly from 210 of method 200 (FIG. 2) to 404, where method 400 listens for user input corresponding to required access credentials and/or a decryption key and determines whether input has been received. In some embodiments, if no input is received at all within a specified time interval at 404, method 400 returns to method 200 at 220 (FIG. 2). If, instead, it is determined at 404 that user input has been received before the expiration of the time interval, then the method 400 proceeds to 406, where method 400 accesses local storage or uses the resources of a remote authentication server to recognize and/or evaluate the user input. The method 400 proceeds to 408 to determine if user entered access and/or decryption key input matches stored value(s). If not, then the method 400 returns to method 200 via 220, but if so, the method returns to method 200 via 222. In the former case, the user is permitted to view only those messages of an exchange or conversation not subject to secure display processing. In the latter case, the user is also permitted to view any messages to which the matching authentication and/or decryption key input pertains.

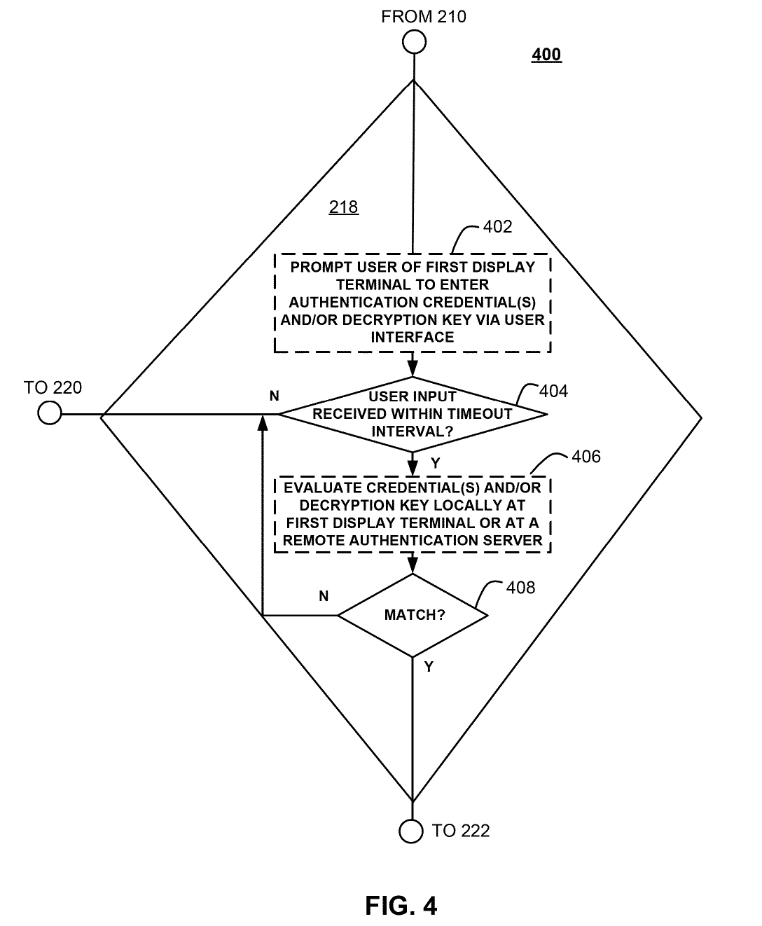

FIG. 5 is a flow diagram of a method 500 for selectively performing secure display processing for a message forming part of an exchange of messages or conversation as, for example, a sub-process of the method 200 of FIG. 2, according to one or more embodiments of the invention. The method 500, as a sub-process of method 200, proceeds from 218 and is initiated at 502. By execution of instructions by a processor residing at the user display terminal and/or at a server (in a server-client arrangement), the method 500 responds at 502 to a determination that the user of the first display terminal is not authorized to view messages, such as the first message received at 204 (FIG. 2), which includes a designation to trigger secure display processing. At 502, method 500 initiates rendering of the messages, such as the second message received at 206 (FIG. 2), for which secure display processing is not applicable or indicated. In some embodiments, those messages for which secure display processing is triggered are concealed rather than displayed. Concealment according to embodiments consistent with the present disclosure is amenable to substantial variation. All or pertinent parts of a message may, for example, be rendered so that the sensitive or confidential content is obstructed as optionally indicated at 504, so that they are hidden as by selecting the same color for the alphanumeric text of the message as the background surrounding the message as optionally indicated at 506, or so that the message is displayed in an encrypted format as optionally indicated at 508. In some embodiments, the message is not rendered to the display at all, such that only a user knowing to look for a visual cue such, for example as one or more displayed symbol(s) or color coding would be able to detect that content or an entire conversation is missing but available subject to authentication and/or decryption. The method 500 returns to method 200 at 212 (FIG. 2).

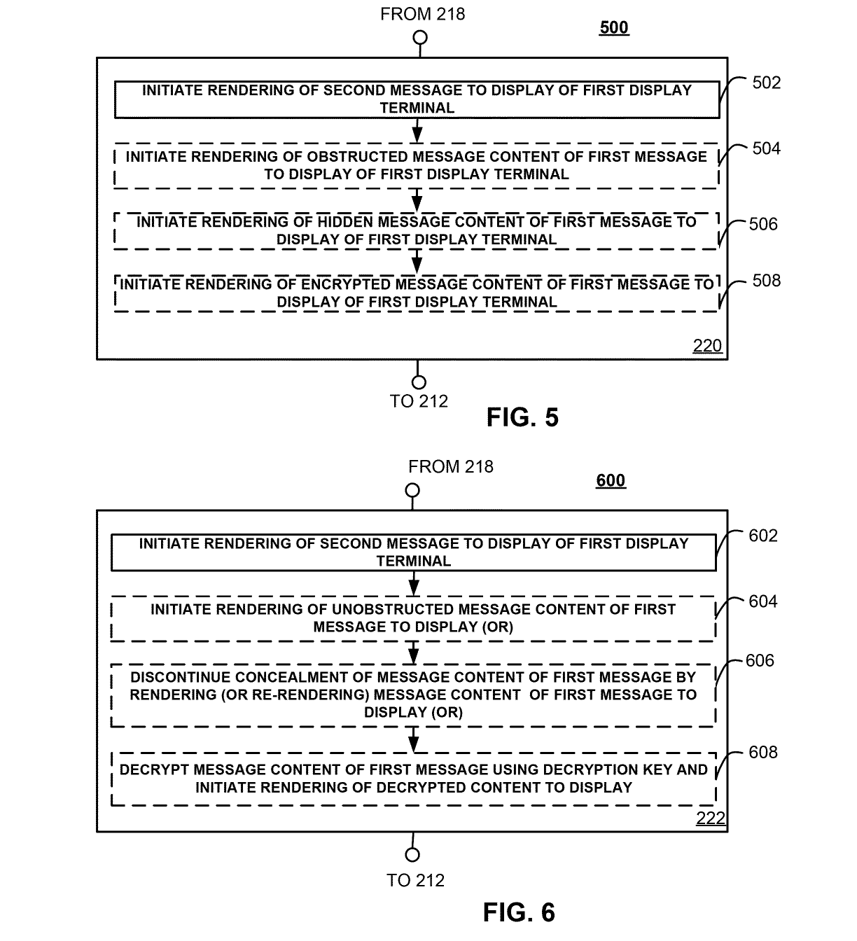

FIG. 6 is a flow diagram of a method 600 for selectively performing secure display processing for a message forming part of an exchange of messages or conversation as, for example, a sub-process of the method 200 of FIG. 2, according to one or more embodiments of the invention. The method 600, as a sub-process of method 200, proceeds from 218. By execution of instructions by a processor residing at the user display terminal and/or at a server (in a server-client arrangement), the method 600 responds at 602 to a determination that the user of the first display terminal is authorized to view messages, such as the first message received at 204 (FIG. 2), to which secure display processing is applicable.

At 602, method 600 initiates rendering of the messages, such as the second message received at 206 (FIG. 2), to which secure display processing is not applicable. Moreover, concealment of messages such as the first message received at 202 of method 200 (FIG. 2) in accordance with previously applied secure display processing is now terminated by method 600. Where concealment was performed by obstructing a message containing the sensitive or confidential content (or a portion of such message), method 600 initiates rendering of an unobstructed version of the message, as optionally shown at 604. Where concealment was performed by withholding a message or its content from rendering altogether, or by rendering the message or its content such that it is indistinguishable from the displayed background, method 600 initiates rendering or re-rendering of the affected message or content so that it can be clearly seen, as optionally shown at 606. Where concealment was performed by encrypting a message containing the sensitive or confidential content (or a portion of such message), method 600 initiates rendering of an unencrypted version of the message, as optionally shown at 608. The method 600 returns to method 200 at 212 (FIG. 2).

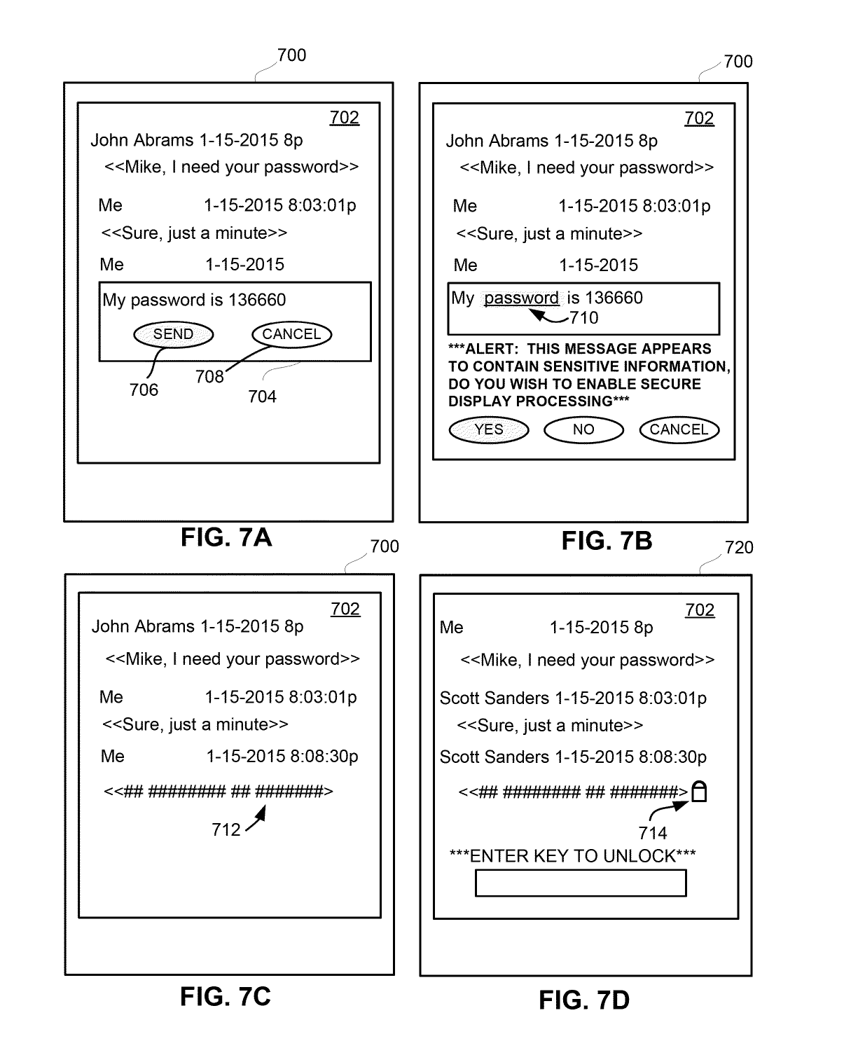

FIG. 7A-7D depicts a display terminal 700 operated by a user to visually present on display 702 a sequence of messages forming at least part of a conversation and to create, edit or forward a message containing sensitive, proprietary, or confidential information as part of that conversation, according to one or more embodiments of the invention. FIG. 7A depicts the display terminal 700 following a user's request to display a pre-existing conversation with a second party via a messaging application such as an IM chat or SMS exchange. In the illustrative example depicted, the user has received a message requesting the entry of information which is of a sensitive nature—a password uniquely assigned to the user. Having operated the display terminal 700 to displayed a user interface of a text editing application, which includes window 704, the user has entered alphanumeric text including both the word “password” and the password itself, the user is presented with a set of “soft” feature buttons permitting the user to cancel and exit the message editing application, as indicated at button 708, or to initiate transmission (forwarding) of the message to the intended recipient, as indicated at button 706. In the illustrative example, the user has utilized a touchscreen and elected to “send” the message by touching the feature button.

FIG. 7B depicts the display terminal 700 of FIG. 7A following the application of keyword recognition to a message created or accessed by the user of display terminal 700, but prior to forwarding of that message to a recipient, the detection of a keyword automatically initiating display of a prompt to the user to invoke secure display processing. In the illustrated example of FIG. 7B, the keyword “password” is highlighted and the user of display terminal 700 is presented with an alert message, and a new set of soft feature buttons have been rendered to the display so the user has the option of enabling secure display processing for the message, to circumvent such processing, or to cancel the send transaction altogether.

FIG. 7C depicts the display terminal 700 of FIGS. 7A and 7B after it has been operated by a user to visually present messages forming part of a conversation that includes at least one message for which secure display processing has been performed and at least one message for which secure display processing has not been performed, according to one or more embodiments of the invention. In this example, obfuscation of the entire message 712 previously appearing in window 704 (FIGS. 7A and 7B) of the user interface has been implemented following storage and retrieval and/or sending of the message 712. FIG. 7D shows the same conversation from the perspective of another party of the same conversation.

As already noted previously, however, the manner in which a message subjected to secure display processing is performed to conceal or omit selected messages or exchanges according to embodiments consistent with the present disclosure are varied and admit of substantial variation. It suffices to say that when the message so sent by the user of display terminal 700 arrives at a second display terminal as display terminal 720 of FIG. 7D, the user of display terminal 720 sees the same conversation. In the illustrative embodiment depicted, the user of display terminal 720 is alerted to the presence of the concealed message by a symbol 714. As previously described, the user may be further prompted with a field for entry of authentication credentials or a decryption code.

In the preceding example of FIGS. 7A-7D, the message created by the user of display terminal 700 is transmitted to the user of the display terminal 720 over a communication network or via peer-to-peer connection. This transmission may be in an unencrypted format, with the encryption and/or other form of concealment applied entirely by each user's display terminal. In other embodiments, the concealed version may be transmitted and/or locally stored with the recipient and/or original author so that each completes an authentication challenge or submits a decryption key each time he or she wishes to view an affected message or conversation free of secure display processing.

It should be noted that although the example of FIGS. 7A-7D depicts a sequence of operation in which the detection of pre-identified keywords causes the automatic invocation of secure display processing according to embodiments consistent with the present disclosure, such detection and/or automatic invocation is optional. In alternate embodiments, the user may simply decide that a particular message or content thereof should be secure. In such embodiments, the user need only enter command as, for example, by gesture, mouse click, soft button, or keyboard depression, to invoke a secure display processing in accordance with the present disclosure.

It should also be noted that although some embodiments described herein have been by reference to the exchange of messages between a single sender and a single recipient, embodiments consistent with the present disclosure are equally applicable to group chat applications wherein three or more participants may exchange and/or access messages subject to secure display processing as described herein.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, embodiments of the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a yy list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of embodiments of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

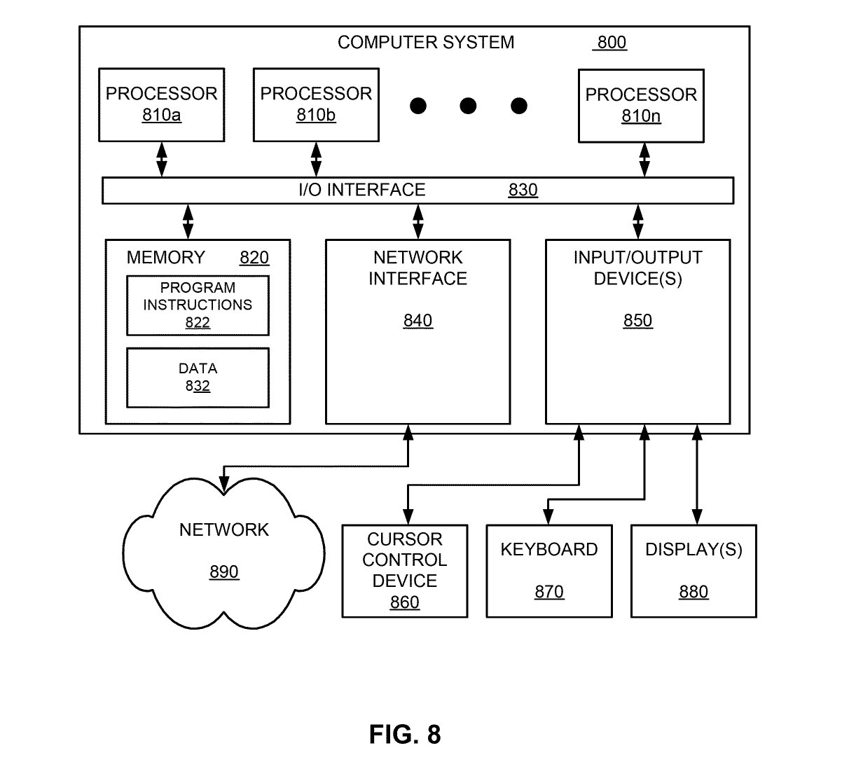

FIG. 8 depicts a computer system 800 that can be utilized in various embodiments of the present invention to implement the computer and/or the display devices, according to one or more embodiments.

Various embodiments of method and apparatus for organizing, displaying and accessing contacts in a contact list, as described herein, may be executed on one or more computer systems, which may interact with various other devices. One such computer system is computer system 800 illustrated by FIG. 8 which may in various embodiments implement any of the elements or functionality illustrated in FIGS. 1-7. In various embodiments, computer system 800 may be configured to implement methods described above. The computer system 800 may be used to implement any other system, device, element, functionality or method of the above-described embodiments. In the illustrated embodiments, computer system 800 may be configured to implement method 200, method 300, method 400, method 500 and/or method 600 as processor-executable executable program instructions 822 (e.g., program instructions executable by processor(s) 810) in various embodiments.

In the illustrated embodiment, computer system 800 includes one or more processors 810a-810n coupled to a system memory 820 via an input/output (I/O) interface 830. Computer system 800 further includes a network interface 840 coupled to I/O interface 830, and one or more input/output devices 850, such as cursor control device 860, keyboard 870, and display(s) 880. In various embodiments, any of the components may be utilized by the system to receive user input described above. In various embodiments, a user interface may be generated and displayed on display 880. In some cases, it is contemplated that embodiments may be implemented using a single instance of computer system 800, while in other embodiments multiple such systems, or multiple nodes making up computer system 800, may be configured to host different portions or instances of various embodiments. For example, in one embodiment some elements may be implemented via one or more nodes of computer system 800 that are distinct from those nodes implementing other elements. In another example, multiple nodes may implement computer system 800 in a distributed manner.

In different embodiments, computer system 800 may be any of various types of devices, including, but not limited to, a personal computer system, desktop computer, laptop, notebook, or netbook computer, mainframe computer system, handheld computer, workstation, network computer, a set top box, a mobile device such as a smartphone or PDA, a consumer device, video game console, handheld video game device, application server, storage device, a peripheral device such as a switch, modem, router, or in general any type of computing or electronic device.

In various embodiments, computer system 800 may be a uniprocessor system including one processor 810, or a multiprocessor system including several processors 810 (e.g., two, four, eight, or another suitable number). Processors 810 may be any suitable processor capable of executing instructions. For example, in various embodiments processors 810 may be general-purpose or embedded processors implementing any of a variety of instruction set architectures (ISAs). In multiprocessor systems, each of processors 810 may commonly, but not necessarily, implement the same ISA.

System memory 820 may be configured to store program instructions 822 and/or data 832 accessible by processor 810. In various embodiments, system memory 820 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 820. In other embodiments, program instructions and/or data may be received, sent or stored upon different types of computer-accessible media or on similar media separate from system memory 820 or computer system 800.

In one embodiment, I/O interface 830 may be configured to coordinate I/O traffic between processor 810, system memory 820, and any peripheral devices in the device, including network interface 840 or other peripheral interfaces, such as input/output devices 850. In some embodiments, I/O interface 830 may perform any necessary protocol, timing or other data transformations to convert data signals from one component (e.g., system memory 820) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. Also, in some embodiments some or all of the functionality of I/O interface 830, such as an interface to system memory 820, may be incorporated directly into processor 810.

Network interface 840 may be configured to allow data to be exchanged between computer system 800 and other devices attached to a network (e.g., network 890), such as one or more display devices (not shown), or one or more external systems or between nodes of computer system 800. In various embodiments, network 890 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 840 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 850 may, in some embodiments, include one or more display terminals, keyboards, keypads, touchpads, scanning devices, voice or optical recognition devices, or any other devices suitable for entering or accessing data by one or more computer systems 800. Multiple input/output devices 850 may be present in computer system 800 or may be distributed on various nodes of computer system 800. In some embodiments, similar input/output devices may be separate from computer system 800 and may interact with one or more nodes of computer system 800 through a wired or wireless connection, such as over network interface 840.

In some embodiments, the illustrated computer system may implement any of the methods described above, such as the methods illustrated by the flowcharts of FIGS. 2-6. In other embodiments, different elements and data may be included.

Those skilled in the art will appreciate that computer system 800 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 800 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or

DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer implemented method, comprising:
receiving a request to display, at a first display terminal, one or more messages collectively defining an exchange between a user of the first display terminal and a user of a second display terminal;
determining, by a processor, that secure display processing should be used on a first group of at least one message of the exchange at the first display terminal; and
displaying message content of a second group of one or more messages of the exchange while concealing message content of the first group of at least one message.

2. The method of claim 1, wherein the one or more messages collectively defining the exchange include at least one of short-message-service (SMS) text messages, instant message (IM) chat messages, multimedia-messaging-service (MMS) messages, or e-mail messages.

3. The method of claim 1, further comprising:
receiving, at the first display terminal, a request to designate one of a locally created message or a received message for secure display processing.

4. The method of claim 3, further comprising:
transmitting a message designated for secure display processing to the second user display terminal.

5. The method of claim 3, wherein receiving a request to designate a message for secure display processing comprises recognizing a gesture entered by a user via a touch screen or touch pad interface.

6. The method of claim 1, wherein determining that secure display processing should be used on the first group of at least one message of the exchange includes at least one of (A) detecting the presence of a keyword indicative of the existence of personal or proprietary information in at least one message of the exchange, or (B) receiving a message of the exchange that includes flagged keywords indicative of the existence of personal or proprietary information.

7. The method of claim 6, wherein detecting the presence of a keyword is performed in response to receiving a request to forward a message locally generated at the first user display terminal.

8. The method of claim 7, further comprising:
initiating, responsive to detecting the presence of a keyword or receiving a message with a flagged keyword, display of a prompt for a user to input a secure display processing designation request for a message containing a keyword indicative of the presence of personal or proprietary information.

9. The method of claim 6, further comprising:
initiating, responsive to detecting the presence of a keyword or receiving a message with a flagged keyword, display of a prompt for a user to input a secure display processing designation request for message or message content containing a keyword indicative of the presence of personal or proprietary information.

10. The method of claim 1, further comprising:
launching a message content creation application from the first display terminal; and
receiving input corresponding to both message content of the at least one message and receiving a request to designate the at least one message for secure display processing.

11. The method of claim 1, wherein concealing message content comprises one of encrypting the at least one message, obfuscating the at least one message, or hiding the at least one message.

12. The method of claim 1, wherein concealing message content comprises one of encrypting a selected portion of the at least one message, obfuscating a selected portion of the at least one message, or hiding a selected portion of the at least one message.

13. The method according to claim 1, further comprising:
prompting, responsive to receiving a request to display the one or more messages, a user of the first display terminal to enter a password if it is determined that secure display processing should be performed on at least one message of the exchange.

14. The method according to claim 13, further comprising:
comparing a password entered by a user against one of a password previously selected by a sender of the at least one message or a password previously selected by a recipient of the at least one message.

15. The method according to claim 14, further comprising:
displaying the at least one message only if the password entered matches the previously selected password.

16. The method according to claim 14, further comprising:
storing, in a memory of the first display terminal, a password selected by the recipient of the at least one message.

17. A computer-implemented method, comprising:
receiving, at a first display terminal, input corresponding to both message content of a first message and to a request to designate the first message for secure display processing;
receiving, at the first display terminal, a second message not designated for secure display processing;
determining that a first user of the first display terminal is authorized to view the first message and initiating display of the first message together with the second message; and
determining that a second user of the first display terminal is authorized is not authorized to view the first message and initiating display of the second message without the first message.

18. The method of claim 17, wherein each of the first and second messages are one of short-message-service (SMS) text messages, instant message (IM) chat messages, multimedia-messaging-service (MMS) messages, or e-mail messages.

19. The method of claim 17, wherein at least some message content of the first message is concealed by encryption or obfuscation when a user of the first display terminal is not authorized to view the first message.

20. A system for managing access to message content at a first user display terminal, comprising:
a display;
a processor; and
a memory containing instructions executable by the processor
to initiate display of one or more messages collectively defining an exchange between a user of the first display terminal and a user of a second display terminal;
to determine secure display processing should be used on a message of the exchange; and
to initiate display of message content of one or more messages of the exchange without displaying message content of messages subject to secure display processing.

21. The system of claim 20, wherein the memory further contains instructions, executable by the processor, for receiving and processing a request to designate one of a locally created message or a received message for secure display processing.

22. The system of claim 21, wherein the instructions executable by the processor for receiving a request to designate a message for secure display processing comprise instructions for recognizing a gesture entered by a user via a touch screen or touch pad interface of the user display terminal.

23. The system of claim 21, wherein the memory further contains instructions, executable by the processor, for detecting, in a locally generated message, a presence of keywords indicative of personal or proprietary information in a message.

24. A system for managing access to message content at a first user display terminal, comprising:
display means for displaying a user interface and one or more messages received at the first user display terminal and collectively defining an exchange between a user of the first display terminal and a user of a second display terminal; and
secure display processing means for determining if secure display processing should be used on a message of the exchange,
wherein the secure display processing means is operative to initiate display of message content for one or more messages of the exchange not determined to require secure display processing without displaying message content of the at least one message if it is determined that secure display processing should be used on a message of the exchange.
